(19) United States
(12) Patent Application Publication
(10) Pub. No.: US 2014/0310776 A1
(43) Pub. Date: Oct. 16, 2014

(54) Control Access Based on Network Status

(71) Applicant: Christoph J. Graham, Houston, TX (US)

(72) Inventor: Christoph J. Graham, Houston, TX (US)

(21) Appl. No.: 14/364,103

(22) PCT Filed: Jan. 26, 2012
(86) PCT No.: PCT/US2012/022752

§ 371 Date: Jun. 10, 2014

(51) Int. Cl. H04L 29/06

(52) U.S. Cl. CPC H04L 63/10
USPC 726/3

(57) ABSTRACT

Embodiments herein relate to controlling access to a device based on status information of a network. The device is connected to and detects status information from the network. Further, the device controls access to a feature of the device based on the detected status information. The device detects the status information and controls access regardless of at least one of a power state of the device and an operating state of an operating system (OS) of the device.

### BACKGROUND

Upon being powered on, a client device may connect to a network. Further, the client device may seek to vary which services it offers based on a status of the network to which the client device is connected. For example, the client device may disable some of its services if the client device is connected to an unknown network. Otherwise, an unauthorized party may gain access to confidential information or services. Manufacturers, vendors, and/or users are challenged to provide more effective methods for controlling a functionality of the client device based on external conditions, such as the status of the network connected to the client device.

### BRIEF DESCRIPTION OF THE DRAWINGS

The following detailed description references the drawings, wherein:

FIG. 1 is an example block diagram of a device;

FIG. 2 is another example block diagram of a device;

FIG. 3 is an example block diagram of a computing device including instructions for controlling access based on network status; and

FIG. 4 is an example flowchart of a method for controlling access based on network status.

### DETAILED DESCRIPTION

Specific details are given in the following description to provide a thorough understanding of embodiments. However, it will be understood by one of ordinary skill in the art that embodiments may be practiced without these specific details. For example, systems may be shown in block diagrams in order not to obscure embodiments in unnecessary detail. In other instances, well-known processes, structures and techniques may be shown without unnecessary detail in order to avoid obscuring embodiments.

A client device may seek to configure its settings or functionality based on a type or status of a network to which the client device is connected. For example, the client device may seek to disable access to some types of confidential information or proprietary services of the client device, if the client device is connected to an unknown network. Generally, the client device determines the status of the network after the client device has been powered on and an operating system (OS) of the client device has been loaded. For example, the OS may communicate with the network via a network controller to determine whether the network is safe.

However, the client device may still be vulnerable to an attack or unauthorized access during a time period in which the client device is already connected to the network but the OS is not yet running or the client device is not powered on. For example, the client device may still be accessed via the network controller before the OS has loaded or when the client device is powered down. Thus, confidential information, proprietary services, system resources, and the like may be accessed by an unauthorized party before the OS even has an opportunity to act. Further, the OS may be corrupted or prevented from running by the unauthorized party, thus indefinitely exposing the proprietary services, system resources, and the like to unauthorized parties.

Embodiments may prevent or reduce the likelihood of the client device being accessed by an unauthorized party over a network. For example, embodiments may detect status information about the network regardless of a power state of the client device or an operating state of an operating system (OS) of the client device. Further, embodiments may control access to the client device based on the detected status information. For instance, embodiments may detect the status information of the network and disable access to a service of or information at the client device, even before the OS is running or the client device is powered on.

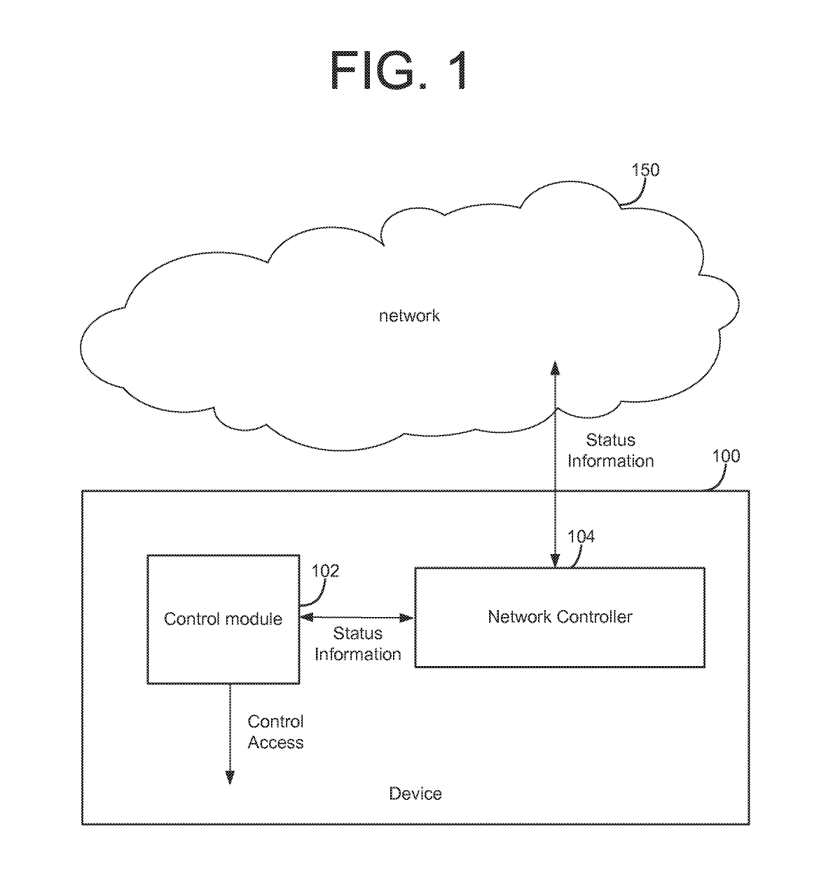

Referring now to the drawings, FIG. 1 is an example block diagram of a device 100. The device 100 may be included in any type of user device to connect to a network 150, such as a secure microprocessor, a notebook computer, a desktop computer, an all-in-one system, a slate computing device, a portable reading device, a wireless email device, a mobile phone, and the like. In the embodiment of FIG. 1, the device 100 includes a control module 102 and a network controller 104.

The control module 102 may include, for example, a hardware device including electronic circuitry for implementing the functionality described below, such as control logic and/or memory. In addition or as an alternative, the control module 102 may be implemented as a series of instructions encoded on a machine-readable storage medium and executable by a processor. For example, the control module 102 may independently run an application and/or operating system (OS) for interfacing with the network controller 104.

The network controller 104 may be any type of device that connects to a network, such as a network interface card. For example, the network controller 104 may include electronic circuitry to communicate using a physical layer and data link layer standard such as Ethernet, Wi-Fi, Token Ring, etc. In FIG. 1, the network controller 104 may connect the device 100, including the control module 102, to the network 150.

The control module 110 is to detect status information from the network 150 via the network controller 104 and to control access to the device 100 based on the detected status information. In FIG. 1, the control module 102 is shown to output a control access signal that may limit access to or functionality of at least part of the device 100. For example, the control module 102 may prevent remote access to the device 100 over the network 150, log out a user using the device 100, restrict access to a service of the device 100, such as a web browser or email client, and the like.

The control module 102 detects the status information regardless of at least one of a power state of the device 100 and an operating state of an operating system (OS) of the device. For example, the control module 102 may detect the status information even if the device 100 is not in a power on state and/or the OS has not yet loaded or is malfunctioning on the device 100. Thus, the control module 102 may detect the status information even while the device 100 is an off state or a powered down state. Further, the control module 102 may detect the status information before or concurrent to a loading of the OS of the device 100. For instance, the control module 102 may detect the status information during a power-on self-test (POST) of the device 100.

In one embodiment, the control module 102 may communicate with the network controller 104 along a separate communication channel, such as a dedicated communication channel that is not used by any other component of the device 100. Thus, embodiments may provide greater control and/or security by controlling a configuration or access to a service or component (not shown) of the device 100, even before the device 100 is powered on or an OS of the device 100 is running.

The control module 102 and the network controller 104 may receive power from a power source when the device 100 is powered down, in order to detect the status information even when the device 100 is powered down. Further, the control module 102 may include software and/or hardware logic that operates separately from the OS of the device 100.

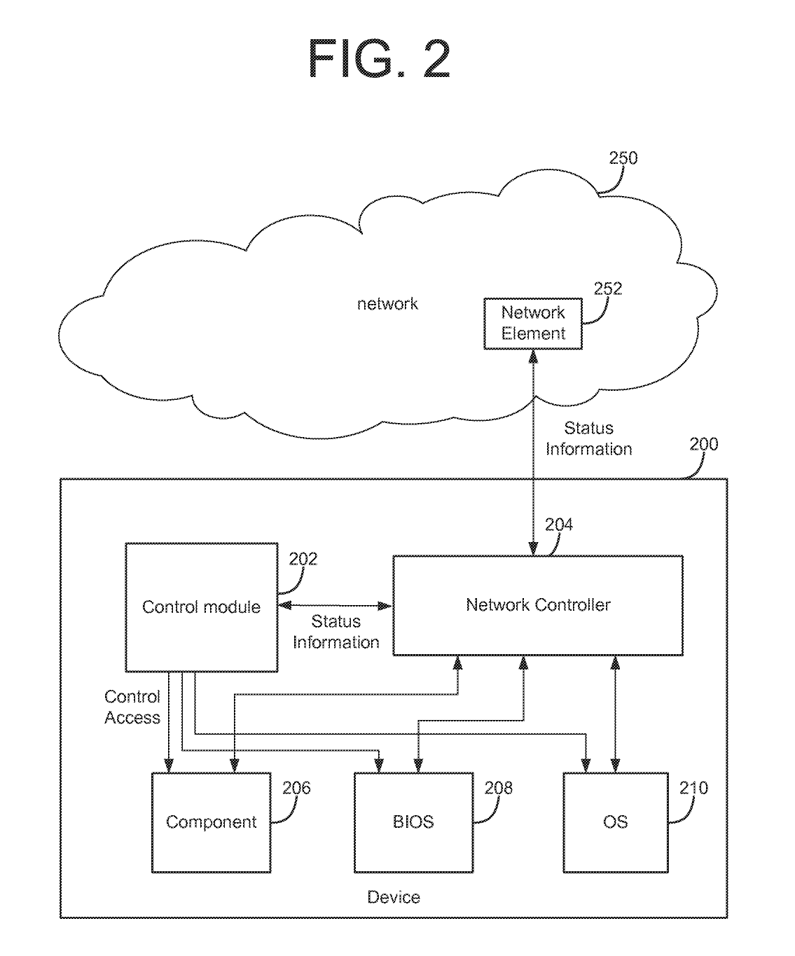

For instance, the control module 102 may include its own OS and/or an application that allows the control module 102 to carry out operations at a network layer, e.g. layer 3 of the Open Systems Interconnection (OSI) model or Internet Protocol model. At the network layer, the control module 120 may communicate with an element (not shown) in the network 150 to detect the status information, as explained in greater detail below with respect to FIG. 2.

FIG. 2 is another example block diagram of a device 200. The client 200 may be included in any type of user device that connects to a network, such as a secure microprocessor, a notebook computer, a desktop computer, an all-in-one system, a slate computing device, a portable reading device, a wireless email device, a mobile phone, and the like. In the embodiment of FIG. 2, the device 200 includes a control module 202, a network controller 204, a component 206, a basic input/output system (BIOS) 208, and an OS 210.

The control module 202 and the network controller 204 of FIG. 2 may be similar to the control module 102 and the network controller 104 of FIG. 1. The network 250 includes a network element 252. Examples of the network element 252 include a router, switch, gateway, domain controller, a server, and the like. The control module 202 may communicate with the network element 252 via the network controller 204 to receive or detect status information from the network element 252.

The detected status information may include a type of the network 250, a state of the device 200 within the network 250, an identity of the device 200 within a hierarchy of the network 250, and the like. Further, the state of the device 200 may include joined to or quarantined within the network 250. If the device 200 is quarantined, the device 200 may be restricted from accessing at least part of the network 250. Examples of type of the network may include a personal area network (PAN), a local area network (LAN), a home network, a storage area network (SAN), a campus network, a backbone network, a Metropolitan area network (MAN), a wide area network (WAN), an enterprise private network, a virtual private network (VPN), an Internetwork, and the like.

The device 200 may determine its identity within a hierarchy of the network, for example, if the control module 202 communicates with the network 250 to have an Internet Protocol (IP) address assigned to the device 200. For example, control module 202 may initially have the IP address assigned by communicating with the network element 252 using a communication protocol, such as Dynamic Host Configuration Protocol, state-less auto-configuration methods, and the like. Upon receiving the IP address, the control module 202 may determine the internet service provider (ISP) and/or a location of the device 200 within the network.

For example, due to the hierarchical addressing schemes of IP addresses, the control module 202 may be able to determine its identity and/or physical location in the network 250. For instance, the control module 202 may be able to trace its place within the hierarchy of the network 250 by analyzing consecutive segments of the IP address. An example hierarchy may include traversing down the following levels: organization, region, locality (such as a region or office), group within a company, and physical location. In addition or alternatively, the control module 202 may be able to determine any of the above information by communicating with the domain controller. Further, if the control module 202 is unable to communicate with the network 250, the control module 202 may determine that it has been quarantined.

Upon detecting the above status information, the control module 202 may control access to and/or configure the component 206, the BIOS 208, the OS 210, and the like. For example, the control module 202 may control access to the BIOS, such as by restricting changes to BIOS settings or modifying the BIOS, such as by flashing the BIOS, in response to the detected status information.

Further, the control module 202 may restrict some operations of the OS 210 and/or prevent some types of services or applications from running on the OS based on the detected status information. Also, if there are multiple OSs included in the device 200, the control module 202 may determine which OS or type of OS will be loaded based on the detected status information.

For example, the control module 202 may prevent a business application, such as an email client, from loading or restrict access to confidential information stored on the device 200, if the control module 202 determines that the device 200 is not connected to the enterprise private network. In another example, the control module 202 may prevent any changes to settings of the OS 210 if the device 200 is located within a staff group of the hierarchy of the network 250 but allow changes to OS settings if the device 200 is located within an administrator group of the hierarchy of the network 250.

Also, the control module 202 may control access to hardware resources of the component 206 or configure the component 206 based on the detected status information. Examples of the component 206 may include a RAM, a memory, a processor, a peripheral device and an input/output (I/O) device. In one instance, the control module 202 may prevent device drivers from being modified if it is determined that the device 200 is not connected to the enterprise private network.

In another instance, the control module 202 may prevent an I/O device, such as a USB drive, from copying information off the device 200, if it is determined that the device 200 is not connected to the enterprise private network. Alternatively, the control module 202 may determine which types of information can be copied based on the type of the network 250 to which the device 200 is connected. For example, the control module 202 may allow only non-confidential information to be copied if the device 200 is connected to the virtual private network (VPN) but not allow any information to be copied if the device 200 is connected to the home network.

In yet another instance, the control module 202 may determine where to store information based on detected status information. For example, the information may be stored to a local memory, such as a hard drive, of the device 200, if the device is connected to the home network, or stored to a network server, if the device is connected to the enterprise private network.

While the control module 202 is shown to be separate from the BIOS 208, embodiments may have the control module 202 included in the BIOS 208. Alternatively, a hypervisor (not shown) may run both the control module 202 and the OS 210. While FIG. 2 shows the control module 202 controlling the network controller 204, the component 206, the BIOS 208, and the OS 210, embodiments are not limited thereto. For example the control module 202 may also control a processor or battery in response to the detected status information. As noted above, embodiments allow the above access and configuration controls to occur even while the device 200 is powered down and/or the before OS 210 or BIOS 209 is running.

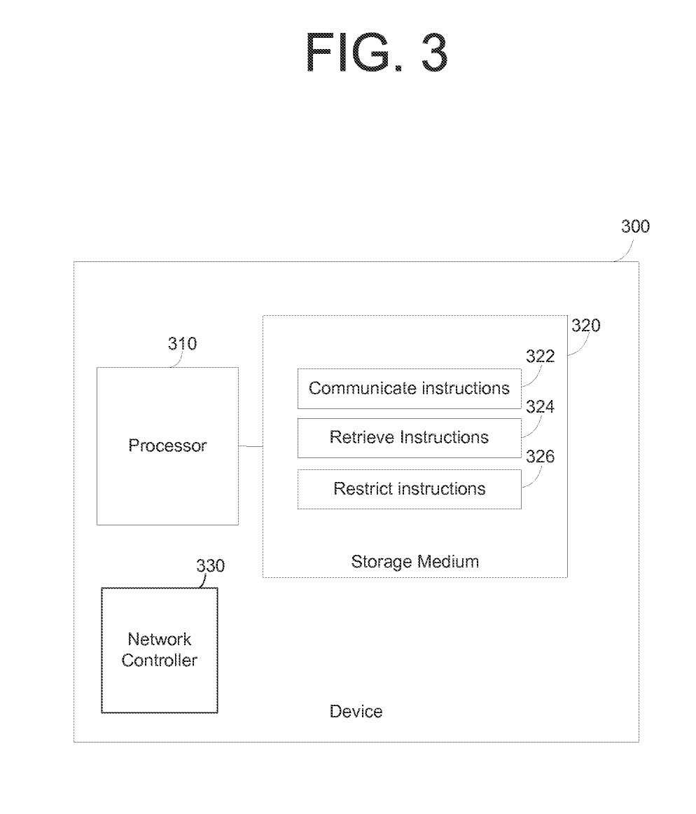

FIG. 3 is an example block diagram of a computing device 300 including instructions for controlling access based on network status. In the embodiment of FIG. 3, the computing device 300 includes a processor 310, a machine-readable storage medium 320 and a network controller 330. The network controller 330 of FIG. 3 may be similar to the network controllers 104 or 204 of FIGS. 1 and 2. The machine-readable storage medium 320 further includes instructions 322, 324 and 326 for controlling access based on network status.

The computing device 300 may be, for example, a chip set, a notebook computer, a slate computing device, a portable reading device, a wireless email device, a mobile phone, or any other type of user device capable of executing the instructions 322, 324 and 326. In certain examples, the computing device 300 may include or be connected to additional components such as memories, sensors, displays, etc.

The processor 310 may be, at least one central processing unit (CPU), at least one semiconductor-based microprocessor, at least one graphics processing unit (GPU), other hardware devices suitable for retrieval and execution of instructions stored in the machine-readable storage medium 320, or combinations thereof. The processor 310 may fetch, decode, and execute instructions 322, 324 and 326 to implement controlling access based on network status. As an alternative or in addition to retrieving and executing instructions, the processor 310 may include at least one integrated circuit (IC), other control logic, other electronic circuits, or combinations thereof that include a number of electronic components for performing the functionality of instructions 322, 324 and 326.

The machine-readable storage medium 320 may be any electronic, magnetic, optical, or other physical storage device that contains or stores executable instructions. Thus, the machine-readable storage medium 320 may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium 320 can be non-transitory. As described in detail below, machine-readable storage medium 320 may be encoded with a series of executable instructions for controlling access based on network status.

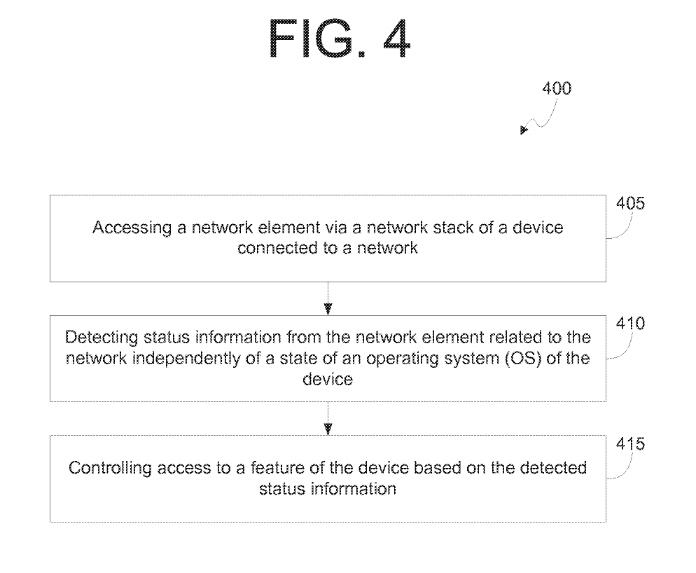

Moreover, the instructions 322, 324 and 326 when executed by a processor (e.g., via one processing element or multiple processing elements of the processor) can cause the processor to perform processes, such as, the process of FIG. 4. For example, the communicate instructions 322 may be executed by the processor 310 to communicate with a network element (not shown) of a network (not shown) via the network controller 330 of the device 300 along a communication channel (not shown). The device 300 is connected to the network and the communication channel is independent of at least one of a power state of the device 300 and an operating state of an OS of the device 300.

The retrieve instructions 324 may be executed by the processor 310 to retrieve status information related to the network from the network element. Examples of the status information are provided above with respect to FIGS. 1 and 2. The restrict instructions 326 may be executed by the processor 310 to restrict access to a feature of the device 300 based on the detected status information. For example, the device 300 may restrict access a basic input/output system (BIOS) of the device, an operating system (OS) of the device and/or a component of the device, based on the detected status information.

The machine-readable storage medium 320 may also include instructions (not shown) to configure a setting of a component (not shown) of the device 300 based on the detected status information. Examples of the component may include a RAM, a memory, a processor, a peripheral device and/or an input/output (I/O) device.

FIG. 4 is an example flowchart of a method 400 for controlling access based on network status. Although execution of the method 400 is described below with reference to the device 200, other suitable components for execution of the method 400 can be utilized, such as the device 100. Additionally, the components for executing the method 400 may be spread among multiple devices (e.g., a processing device in communication with input and output devices). In certain scenarios, multiple devices acting in coordination can be considered a single device to perform the method 400. The method 400 may be implemented in the form of executable instructions stored on a machine-readable storage medium, such as storage medium 320, and/or in the form of electronic circuitry.

At block 405, the device 200 accesses the network element 252 via a network stack of the device 200 connected to the network 250. The network stack may be part of a computer networking protocol suite, usually a lower protocol related to a media layer. For example, in the Open Systems Interconnection (OSI) model or the Internet Protocol model, the network stack may include at least one of the physical, data link and network layers.

Then, the device 200 detects status information from the network element 252 related to the network 250 independently of a state of an OS of the device 200. Lastly, the device 200 controls access to a feature of the device 200 based on the detected status information. The detected status information may include at least one of a type of the network 250, a state of the device 200 within the network 250, and an identity of the device 200 within a hierarchy of the network 250. The state of the device 200 includes at least one of joined to and quarantined within a part of the network 250. Features of the device 200 that may be controlled by the device in response to the detected status information are explained above with respect to FIGS. 1 and 2.

According to the foregoing, embodiments provide a method and/or device for controlling access to information or services of a device based on a status of a network to which the device is connected. In addition, embodiments may prevent or reduce the likelihood of the device being accessed by an unauthorized party over the network. For example, embodiments may detect the status information of the network and disable access to or configure a service or information of the device, even before the OS is running or the device is powered on.

We claim:

1. A client device comprising:
a network controller to connect the client device to a network; and
a control module to detect status information from the network via the network controller and to control access to the client device based on the detected status information, wherein
the control module detects the status information regardless of at least one of a power state of the client device and an operating state of an operating system (OS) of the client device.

2. The client device of claim 1, wherein the control module is to communicate with the network controller at least one of when the operating state of the OS is not an on state and when the power state of the client device is an off state.

3. The client device of claim 2, wherein the control module is to access the network controller to detect the status information before a loading of OS of the client device.

4. The client device of claim 3, wherein the control module determines a type of the OS to load based on the detected status information.

5. The client device of claim 1, wherein the control module controls access to at least one of a basic input/output system (BIOS) of the client device, an operating system (OS) of the client device and a component of the client device based on the detected status information.

6. The client device of claim 5, wherein the control module controlling access to the client device further includes at least one of controlling access to settings of the BIOS, hardware resources of the component, and permission for the OS to perform a service.

7. The client device of claim 6, wherein the control module configures the component based on the detected status information, the component including at least one of a RAM, a memory, a processor, a peripheral device and an input/output (I/O) device.

8. The client device of claim 1, wherein the control module is included in at least one a basic input/output system (BIOS) and a hypervisor.

9. The client device of claim 1, wherein the detected status is retrieved by the control module from at least one of a router, a switch, a gateway, a domain controller and a server included in the network.

10. The client device of claim 1, wherein
the detected status information includes at least one of a type of the network, a state of the client device within the network, and an identity of the client device within a hierarchy of the network, and
the state of the client device includes at least one of joined to and quarantined within a part of the network.

11. A method, comprising:
accessing a network element via a network stack of a device connected to a network;
detecting status information from the network element related to the network independently of a state of an operating system (OS) of the device; and
controlling access to a feature of the device based on the detected status information.

12. The method of claim 11, wherein
the detected status information includes at least one of a type of the network, a state of the device within the network, and an identity of the device within a hierarchy of the network, and
the state of the device includes at least one of joined to and quarantined within the network.

13. A non-transitory computer-readable storage medium storing instructions that, if executed by a processor of a device, cause the processor to:
communicate with a network element of a network via a network controller of the device along a communication channel, where the device is connected to the network and the communication channel is independent of at least one of a power state and an operating state of the device;
retrieve status information from the network element related to the network; and
restrict access to a feature of the device based on the detected status information.

14. The non-transitory computer-readable storage medium of claim 13, wherein the restrict includes restricting access to at least one of a basic input/output system (BIOS) of the device, an operating system (OS) of the device and a component of the device, based on the detected status information.

15. The non-transitory computer-readable storage medium of claim 14, further comprising instructions that, if executed by the processor, cause the processor to:
configure a setting of the component based on the detected status information, the component including at least one of a RAM, a memory, a processor, a peripheral device and an input/output (I/O) device.
